(19) United States
(12) Patent Application Publication
(10) Pub. No.: US 2004/0264911 A1
(43) Pub. Date: Dec. 30, 2004

(54) Optical waveguide, area light source apparatus, and liquid crystal display

(76) Inventors: Minoru Toeda, Kariya-shi (JP); Naoyuki Yamamoto, Kariya-shi (JP); Takaaki Konoma, Kariya-shi (JP); Eiki Niida, Kariya-shi (JP); Fumikazu Isogai, Kariya-shi (JP)

Correspondence Address: MORGAN & FINNEGAN, L.L.P., 3 WORLD FINANCIAL CENTER, NEW YORK, NY, 10281-2101, US

(21) Appl. No.: 10/876,043

(22) Filed: Jun. 24, 2004

(30) Foreign Application Priority Data
Jun. 26, 2003 (JP) 2003-183407
Aug. 8, 2003 (JP) 2003-206699

(51) Int. Cl. G02B 6/10

(52) U.S. Cl. 385/146

(57) ABSTRACT

An optical waveguide according to the present invention has a light exit surface located on a side opposite of a back surface. An incident surface connects the back surface and the light exit surface with each other. A plurality of saw-tooth grooves are formed on the back surface. Surfaces defining the saw-tooth grooves include first guide surfaces that reflect light that enters the optical waveguide through the incident surface so that the light advances toward the first guide surface. A plurality of curved surface prisms are provided on the light exit surface. Each prism has a peak line. An arcuate cross-section groove is provided between the peak lines of each adjacent pair of the prisms. Each arcuate cross-section groove is defined by a section of the light exit surface between the peak lines of the corresponding prisms. Each of the sections of the light exit surface defining the arcuate cross-section grooves has a bottom portion that is located closer to the back surface than a midpoint of the groove in the depth direction. An angle defined by a tangent plane of each bottom portion at a point on the bottom portion and a hypothetical plane containing the peak lines of all the projections decreases as the point approaches the back surface.

### BACKGROUND OF THE INVENTION

The present invention relates to an optical waveguide, an area light source apparatus, and a liquid crystal display. More particularly, the present invention pertains to an optical waveguide that receives light generated by point light sources such as light emitting diodes (LED) and emits the received light through an area, and to an area light source apparatus and a liquid crystal display having such an optical waveguide.

Certain types of liquid crystal displays include a liquid crystal panel and an area light source apparatus functioning as a backlight. The area light source apparatus is provided on a back surface of the liquid crystal panel, which faces away from the display surface of the liquid crystal panel. Some area light source apparatus includes an optical waveguide and a fluorescent tube (a cold cathode tube). An optical waveguide is formed of a highly translucent material. A fluorescent tube is provided along an edge of the optical waveguide. As the thickness of liquid crystal displays is reduced, the diameter of the fluorescent tubes is desired to be reduced, accordingly. However, as the diameter of a fluorescent tube is reduced, the tube is more easily damaged by smaller impacts. Further, to cause a fluorescent tube to emit a sufficient amount of light so that the tube functions as a light source, a relatively high voltage must be applied to the tube, which requires a complicated lighting circuit.

Accordingly, an area light source apparatus of an edge light type (side light type) having an LED instead of a fluorescent tube has been proposed. In such an apparatus, an LED is provided to face an edge of an optical waveguide. Light from the LED is emitted from a light exit surface of the waveguide that faces a liquid crystal panel. That is, light exits the waveguide through an area. However, in such an area light source apparatus, defective emission lines and brightness unevenness appear due to the strong directivity of the light from the LED.

Therefore, some area light source apparatus includes a diffusion sheet or diffusion dots provided on the optical waveguide. The diffusion sheet and the diffusion dots diffuse light from the LED to reduce the directivity of the light. An area light source apparatus of this type typically has one or two prism sheets for gathering light so that a sufficient brightness is obtained. Accordingly, an area light source apparatus of this type has an increased number of components, which increases the number of assembling processes and the costs.

Japanese Laid-Open Patent Publication No. 2003-75649 discloses a technique in which light from one or a small number of LEDs is diffused by an optical waveguide so that the directivity of the LEDs is reduced. FIG. 13 illustrates an area light source apparatus disclosed in Japanese Laid-Open Patent Publication 2003-75649. The apparatus includes an LED 41, an optical waveguide 44, and an optical deflector 45. The optical waveguide 44 has an incident surface 42 facing the LED 41, and a light exit surface 43 facing the optical deflector 45. A parallel array of lenses 44a is provided on a surface of the optical waveguide 44 that faces away from the light exit surface 43. The direction in which the lenses 44a extend is parallel to the direction of light from the LED 41 that enters the optical waveguide 44 through the incident surface 42. The light of the LED 41 that enters the optical waveguide 44 through the incident surface 42 is diffused to be widely distributed in an XY plane before emitted from the waveguide 44 through the light exit surface 43. As shown in FIG. 14, the direction of light that is emitted through the light exit surface 43 is shifted to a front direction by the optical deflector 45. Japanese Laid-Open Patent Publication No. 2003-75649 also discloses an alternative embodiment in which, in stead of roughening the light exit surface 43, other parallel array of lenses extending perpendicular to the lenses 44a are provided on the light exit surface 43.

According to the techniques disclosed in Japanese Laid-Open Patent Publication No. 2003-75649, the array of lenses 44a on a surface of the optical waveguide 44 that faces away from the light exit surface 43, together with the array of lenses on the light exit surface 43, changes light that enters the optical waveguide 44 through the incident surface 42 into an uniform area light that exits the optical waveguide 44 through the light exit surface 43. However, although the lens arrays are capable of diffusing light that enters the optical waveguide 44 so that the light is widely distributed in the XY plane, the lens arrays cannot cause the light to exit the waveguide 44 so that the light advances in the front direction. Thus, the optical deflector 45 is indispensable for shifting the direction of light that exits the optical waveguide 44.

In a conventional edge light type area light source apparatus, regardless whether a point light source or a linear light source is used, the ratio of the amount of light that exits the optical waveguide along a direction perpendicular to the light exit surface of the optical waveguide through the light exit surface to the amount of light that enters the optical waveguide through an edge of the optical waveguide is small. In other words, light that enters the optical waveguide through an edge of the optical waveguide is not effectively used. Japanese Laid-Open Patent Publication No. 10-282342 discloses an improved optical waveguide that eliminates the drawback. The improved optical waveguide has regularly arranged microscopic prisms on the light exit surface. Projections or recesses are provided on a surface of the optical waveguide that faces away from the light exit surface. The projections or recesses are spaced at a predetermined interval and extend in a direction perpendicular to the extending direction of the microscopic prisms. Each projection or recess defines slopes having different sizes. The projected area of one of the slopes onto the light exit surface is no less than three times the projected area of the other slope onto the light exit surface.

The optical waveguide disclosed in Japanese Laid-Open Patent Publication No. 10-282342 receives light through one of the edges and effectively emits the light through the light exit surface. This contributes to a reduction of the number of prism sheets required for the area light source apparatus. However, the optical waveguide cannot eliminate the defective emission lines when a point light source is used.

### SUMMARY OF THE INVENTION

Accordingly, it is an objective of the present invention to provide an optical waveguide that receives light and effectively emits the received light in a desired direction and prevents the creation of defective emission lines, and to provide an area light source apparatus and a liquid crystal display having such an optical waveguide.

To achieve the above objective, the present invention provides an optical waveguide. The optical waveguide includes a first surface and a second surface. The first and second surfaces are located at opposite sides of the optical waveguide. A third surface connects the first and second surfaces with each other. The optical waveguide receives light through the third surface and emits the light to the outside through an area on the second surface. A plurality of first grooves are formed on the first surface. Each first groove is defined by a section of the first surface. Each of the section of the first surface defining the first grooves includes a reflection surface. Each reflection surface reflects light that enters the optical waveguide through the third surface so that the light advances toward the second surface. The extending direction of the reflection surfaces is parallel to the third surface. A plurality of projections are formed on the second surface. The projections extend perpendicular to the extending direction of the reflection surfaces. Each projection has a peak line. A second groove is provided between the peak lines of each adjacent pair of the projections. Each second groove is defined by a section of the second surface between the peak lines of the corresponding projections. Each of the sections of the second surface defining the second grooves includes a bottom portion. The bottom portion is located closer to the first surface than a midpoint of the second groove in the depth direction. An angle defined by a tangent plane of each bottom portion at a point on the bottom portion and a hypothetical plane that contains the peak lines of all the projections decreases as the point approaches the first surface.

The present invention also provides an area light source apparatus. The area light source apparatus includes a point light source and the optical waveguide, which receives light generated by the point light source.

Further, the present invention provides a liquid crystal display. The liquid crystal display includes a liquid crystal panel having a display surface, and an area light source apparatus provided on a surface of the liquid crystal panel that faces away from the display surface. The area light source apparatus includes a point light source and the optical waveguide, which receives light generated by the point light source.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a perspective view schematically illustrating an optical waveguide according to a first embodiment;

FIG. 1(b) is an enlarged partial perspective view illustrating the optical waveguide of FIG. 1(a);

FIG. 1(c) is an enlarged partial perspective view illustrating the back surface of the optical waveguide of FIG. 1(a);

FIG. 2 is a side view schematically illustrating a liquid crystal display having the optical waveguide of FIG. 1(a);

FIG. 3 is a schematic view illustrating an operation of the optical waveguide of FIG. 1(a);

FIG. 4(a) is a schematic view showing an operation of an optical waveguide having a flat light exit surface;

FIG. 4(b) is a schematic view showing an operation of an optical waveguide having flat surface prisms on a light exit surface;

FIG. 5(a) is a schematic plan view illustrating an optical waveguide on which defective emission lines are present;

FIG. 5(b) is a schematic perspective view showing an operation of the optical waveguide shown in FIG. 4(b);

FIGS. 6(a) and 6 (b) are schematic views showing operations of the optical waveguide shown in FIG. 1(a);

FIG. 7 is a schematic plan view showing the optical waveguide shown in FIG. 1(a), which is used in optical simulations;

FIG. 8(a) is a graph representing a cross-sectional profile of curved surface prisms in the optical waveguide shown in FIG. 1(a);

FIG. 8(b) is a graph representing a cross-sectional profile of flat surface prisms shown in FIG. 4(b);

FIG. 9(a) is a schematic perspective view illustrating an optical waveguide according to a second embodiment of the present invention;

FIG. 9(b) is a schematic plan view illustrating a light admitting portion formed on the optical waveguide shown in FIG. 9(a);

FIGS. 10(a) to 10 (c) are schematic views showing optical waveguides of modifications;

FIGS. 11(a) to 11(c) are schematic views showing optical waveguides of other modifications;

FIG. 12 is a schematic plan view illustrating a light admitting portion formed on an optical waveguide of another modification;

FIG. 13 is a schematic perspective view illustrating a prior art area light apparatus;

FIG. 14 is a partial side view for explaining an operation of the area light apparatus shown in FIG. 13;

FIG. 15 is a graph showing the relationship between a prism inclination angle and an output angle; and

FIG. 16 is a schematic plan view illustrating a light admitting portion formed on the optical waveguide shown in FIG. 9(a) used in optical simulations.

### DETAILED DESCRIPTION OF THE PREFERRED EMBODIMENTS

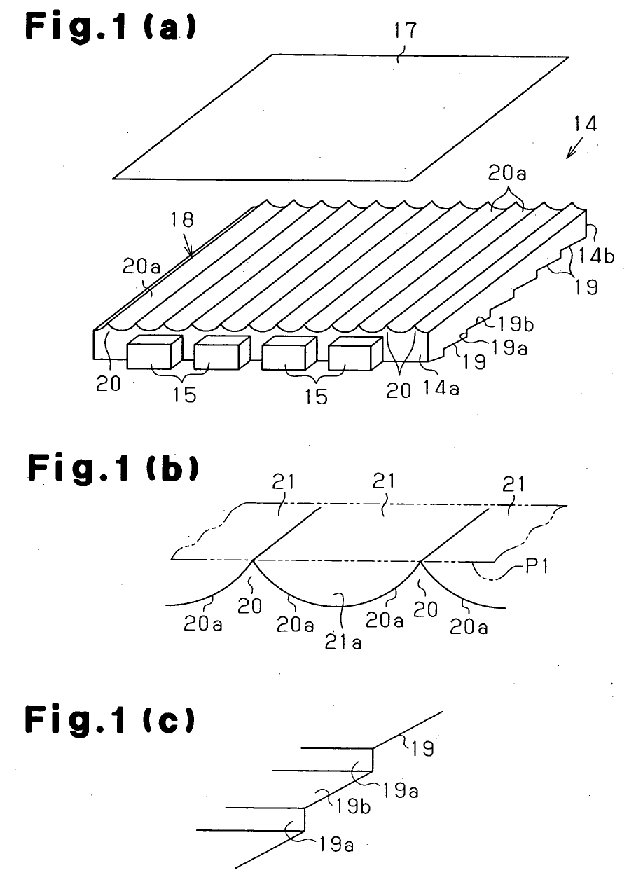

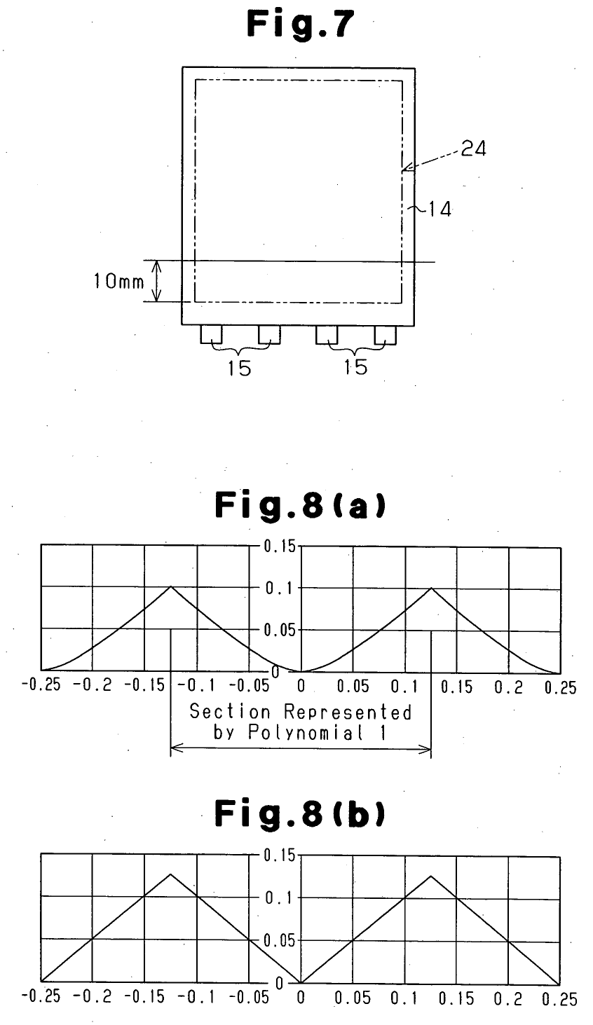

A first embodiment of the present invention will now be described with reference to FIGS. 1(a) to 8 (b).

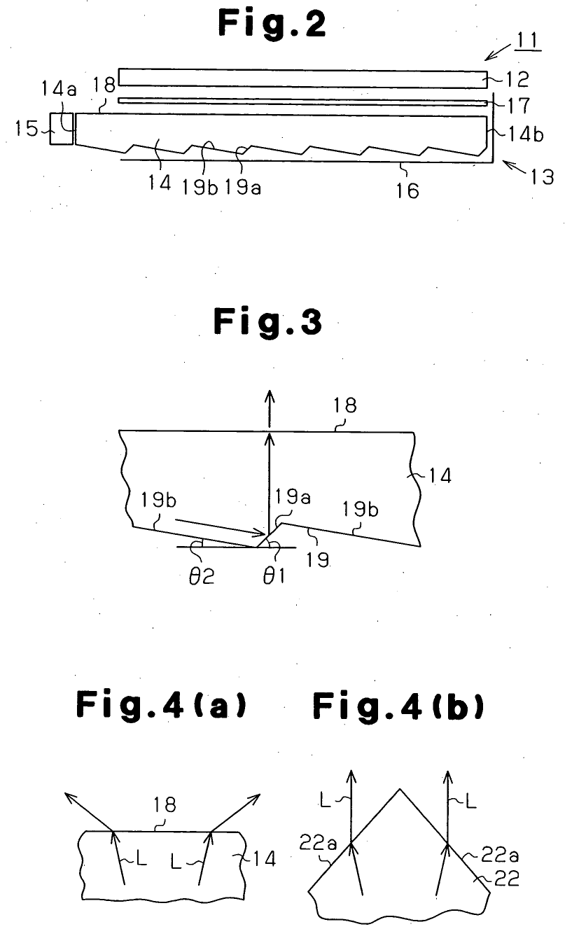

As shown in FIG. 2, a transmissive liquid crystal display 11 according to his embodiment includes a liquid crystal panel 12 and an area light source apparatus 13, which functions as a side light type backlight unit. The liquid crystal panel 12 has a display surface. The area light source apparatus 13 is provided at a side of the liquid crystal panel 12 that faces away from the side of the display surface. The area light source apparatus 13 includes an optical waveguide 14 and point light sources 15, which are LEDs. As shown in FIG. 1(a), the number of the point light sources 15 may be four. The point light sources 15 are arranged to face an incident surface 14a (third surface), which is an edge of the optical waveguide 14.

As shown in FIG. 2, a reflection member 16, which is formed of a sheet, is provided in the neighborhood of the area light source apparatus 13. The reflection member 16 is provided at a side of the optical waveguide 14 where the liquid crystal panel 12 is not located. The reflection member 16 reflects light that leaks from the optical waveguide 14 backto the waveguide 14. Light that is returned to the waveguide 14 is emitted from the waveguide 14 through a light exit surface 18 (second surface), which is a surface of the waveguide 14 that faces the liquid crystal panel 12. A diffusion sheet 17 is provided between the optical waveguide 14 and the liquid crystal panel 12.

The optical waveguide 14 is formed of a highly transparent material such as an acrylic resin. As shown in FIG. 1(a), the optical waveguide 14 is substantially rectangular as viewed from the top. As shown in FIGS. 1(a), 1(c), and 3, saw-tooth shaped grooves 19 (first grooves) are formed on a back surface (first surface) of the optical waveguide 14 that faces away from the light exit surface 18, so that the back surface has a saw-tooth cross-section. The saw-tooth shaped grooves 19 extend parallel to one another. Each saw-tooth shaped grooves 19 is defined by a first guide surface 19a (reflection surface) and a second guide surface 19b. Each first guide surface 19 a is closer to the incident surface 14a than the corresponding second guide surface 19b. The optical waveguide 14 has an opposite surface 14b, or an edge of the waveguide 14 that faces away from the incident surface 14a. Each first guide surface 19a is inclined so that a portion of the first guide surface 19a closer to the opposite surface 14b is closer to the light exit surface 18 than a portion of the first guide surface 19a closer to the incident surface 14a. Each second guide surface 19b is inclined so that a portion of the second guide surface 19b closer to the opposite surface 14b is farther away from the light exit surface 18 than a portion of the second guide surface 19b closer to the incident surface 14a. The first guide surfaces 19a and the second guide surfaces 19b are alternately and successively formed on the back surface of the optical waveguide 14. The direction in which the saw-tooth shaped grooves 19 extend is parallel to the incident surface 14a and the opposite surface 14b. Also, the direction in which the first guide surfaces 19a and the second guide surfaces 19b extend is parallel to the incident surface 14a and the opposite surface 14b.

An angle defined by each first guide surface 19a and a hypothetical plane P1, which will be discussed below, (see FIG. 1(b)) is determined so that light that enters the optical waveguide 14 through the incident surface 14a and reaches the first guide surface 19a, more particularly, light that advances in a direction parallel to the hypothetical plane P1 in the optical waveguide 14, is totally reflected on the first guide surface 19a and advances toward the light exit surface 18 along a direction substantially perpendicular to the hypothetical plane P1. An angle θ1 defined by each first guide surface 19a and a plane parallel to the hypothetical plane P1 (see FIG. 3) is preferably in a range no less than 35° and no more than 50°, and more preferably in a range no less than 40° and no more than 45°. An angle θ2 defined by each second guide surface 19b and a plane parallel to the hypothetical plane P1 (see FIG. 3) is preferably in a range no less than 0.3° and no more than 2.5°.

As shown in FIGS. 1(a) and 1(b), the optical waveguide 14 has curved surface prisms 20 (projections) on the light exit surface 18. The prisms 20 extend parallel to one another in a direction perpendicular to a direction along which the saw-tooth shaped grooves 19 extend. The prisms 20 are arranged so that each adjacent pair of the prisms 20 are continuous. The prisms 20 have the same size. As shown in FIG. 1(b), the peak lines of the prisms 20 are located in the hypothetical plane P1. A section of the light exit surface 18 between the peak lines of each adjacent pair of the prisms 20 is a curved surface 20a projecting toward the back surface of the optical waveguide 14. That is, an arcuate cross-section groove 21 (second groove) is defined between the peak lines of each adjacent pair of the prisms 20. Each arcuate cross-section groove 21 is defined by the corresponding curved surface 20a.

Each curved surface 20a includes a bottom portion 21a that is closer to the back surface of the optical waveguide 14 than a midpoint in the depth of the groove 21. An angle defined by the hypothetical plane P1 and a tangent plane of the bottom portion 21a at a point on the bottom portion 21a decreases as the point approaches the back surface of the optical waveguide 14. At a point on the bottom portion 21a that is closest to the back surface of the optical waveguide 14, the tangent plane of the bottom portion 21a is parallel to the hypothetical plane P1. That is, the minimum value of the angle defined by the hypothetical plane P1 and a tangent plane of the bottom portion 21a at a point on the bottom portion 21a is 0°.

The minimum value of the angle defined by the hypothetical plane P1 and a tangent plane of the bottom portion 21a at a point on the bottom portion 21a does not need to be zero degrees, as long as the angle is at least no more than 10°. The reasons why the minimum value of the angle defined by the hypothetical plane P1 and the tangent plane of the bottom portion 21a is preferably no more than ten degrees are as follows.

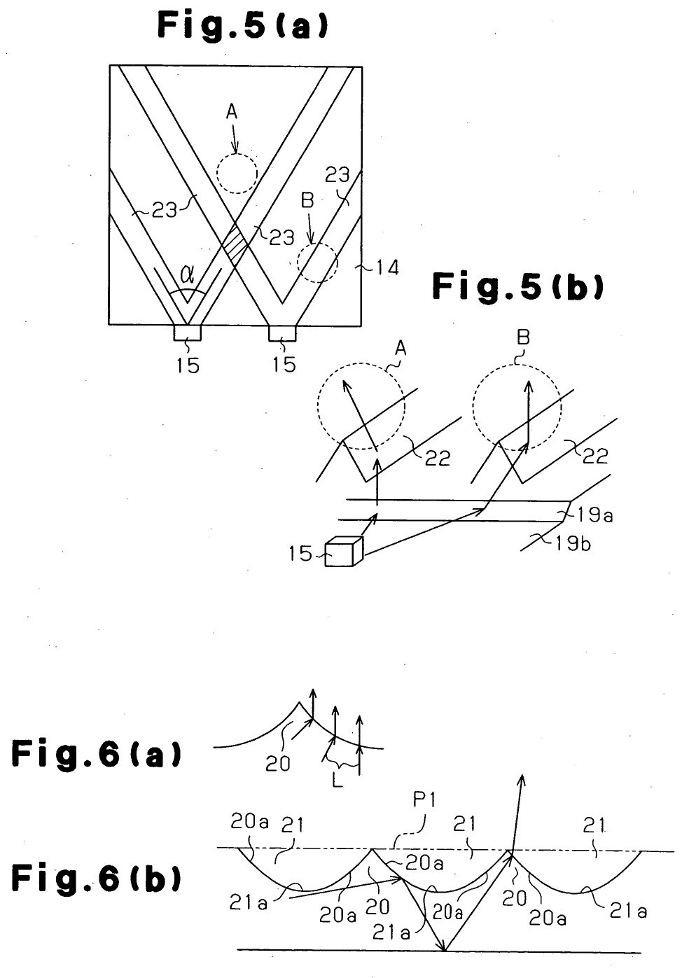

Most of light that is reflected on the first guide surfaces 19 a toward the light exit surface 18 advances through the optical waveguide 14 in a direction perpendicular to the hypothetical plane P1. However, strictly speaking, as shown in FIG. 5(b), the direction in which light generated by each point light source 15 advances when it is reflected on one of the first guide surfaces 19a varies depending on the position of the point light source 15 relative to a portion of each first guide surface 19a that admits the light from the light source 15. Specifically, in each first guide surface 19a, the angle defined by the hypothetical plane P1 and the direction in which light reflected on the first guide surface 19a is closer to a right angle in an area in front of each point light source 15 than in an area away from there. That is, a portion of each first guide surface 19 a that is located in front of each point light source 15 reflects light from the point light source 15 so that light advances toward the light exit surface 18 in a direction perpendicular to the hypothetical plane P1. When light that has been reflected to advance in a direction perpendicular to the hypothetical plane P1 reaches one of the curved surfaces 20a, if the angle at the incident point defined by the hypothetical plane P1 and the tangent plane of the curved surface 20a is large, the light that has reached the incident point is refracted to advance in a direction that is greatly different from a direction perpendicular to the hypothetical plane P1. As a result, the amount of light that is emitted in the front direction of the optical waveguide 14 is decreased, and dark lines and dark spots of a lower brightness appear in areas of the optical waveguide 14 in front of the point light sources 15.

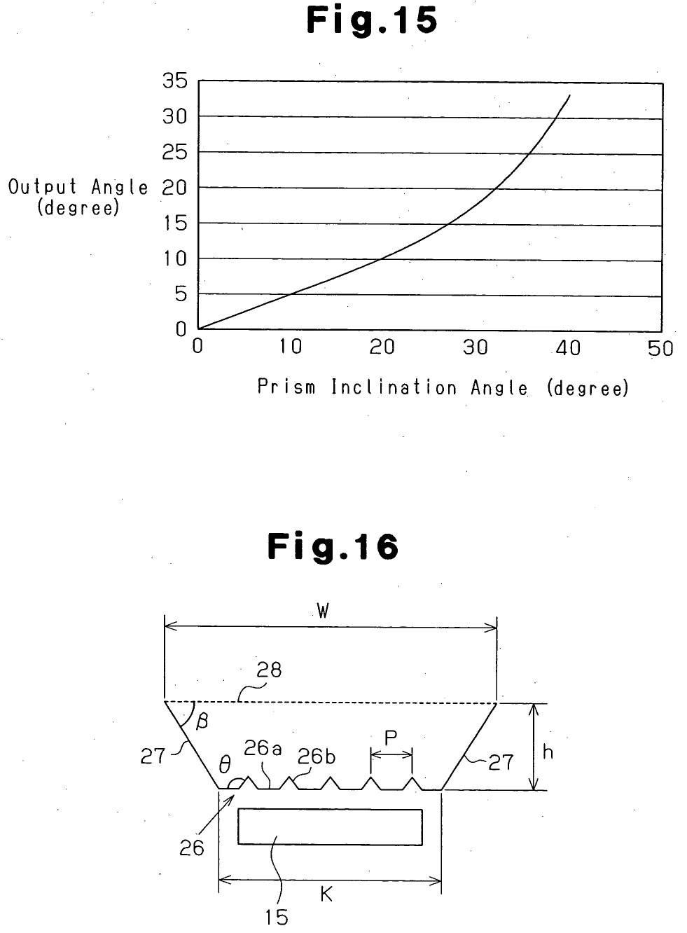

FIG. 15 is graph showing the relationship between an output angle and a prism inclination angle. The output angle refers to an angle defined by a straight line perpendicular to the hypothetical plane P1 and a direction of light that leaves one of the curved surfaces 20a after being reflected to advance in a direction perpendicular to the hypothetical plane P1 and reaching the curved surface 20a. The prism inclination angle refers to an angle defined by the hypothetical plane P1 and the tangent plane of the curved surface 20a at an incident point on the curved surface 20a. Users of the liquid crystal display 11 typically views the display surface from a position in front of the display surface, or from a position in an angle range within ±5° from the front direction of the optical waveguide 14. Therefore, the output angle needs to be no more than approximately 5° in practical use. Accordingly, the results shown in FIG. 15 suggest that the minimum value of the angle defined by the tangent plane of each bottom portion 21a and the hypothetical plane P1 is preferably no more than 10°.

An operation of the optical waveguide 14 will now be described.

When the point light sources 15 emit light, the light enters the optical waveguide 14 through the incident surface 14a. As shown in FIG. 3, when light that enters the optical waveguide 14 reaches any of the first guide surfaces 19a, the light is totally reflected to advance toward the light exit surface 18. Thereafter the light exits the optical waveguide 14 through the light exit surface 18 toward the liquid crystal panel 12. Light that has exited the optical waveguide 14 enters the liquid crystal panel 12 through the diffusion sheet 17, and is used to visualize images on the display surface of the liquid crystal panel 12.

Light that reaches the first guide surfaces 19a includes not only light that travels directly from the incident surface 14a toward any of the first guide surfaces 19a and reaches the first guide surface 19a, but also light that does not travel directly from the incident surface 14 a toward any of the first guide surfaces 19a but reaches any of the first guide surface 19a after being totally reflected on any of the second guide surfaces 19b or the light exit-surface 18. Light that travels directly from the incident surface 14a toward any of the first guide surfaces 19a advances in the optical waveguide 14 substantially parallel to the hypothetical plane P1 (see FIG. 1(b)). On the other hand, since each second guide surface 19b is inclined so that a portion of the second guide surface 19 b that is closer to the opposite surface 14b is located farther away from the light exit surface 18 than a portion of the second guide surface 19b that is closer to the incident surface 14a, light that does not travel directly from the incident surface 14a toward any of the first guide surfaces 19a is repeatedly totally reflected on the second guide surfaces 19b and the light exit surface 18 until the light advances in the optical waveguide 14 along a line substantially parallel to the hypothetical plane P1. Therefore, light that travels directly from the incident surface 14a toward any of the first guide surfaces 19a and light that does not travel directly from the incident surface 14a toward any of the first guide surfaces 19a are both totally reflected on the first guide surfaces 19a so that the lights advance toward the light exit surface 18 in angles substantially perpendicular to the hypothetical plane P1.

The refractive index of the optical waveguide 14 is greater than the refractive index of air. Therefore, when entering the optical waveguide 14, light is refracted by an angle of refraction that is greater than the angle of incidence at an interface between the optical waveguide and air. Thus, assuming that the light exit surface 18 is formed flat without the curved surface prisms 20 as shown in FIG. 4(a), rays L of light that have been reflected on one of the first guide surfaces 19a toward the light exit surface 18 are refracted on the light exit surface 18 to advance in a direction that is greatly displaced from a direction perpendicular to the light exit surface 18. That is, the flat light exit surface 18 shown in FIG. 4(a) cannot emit light in a front direction.

On the other hand, assuming that the curved surface prisms 20 are replaced by flat surface prisms 22 as shown in FIG. 4(b), rays L of light that have been reflected on one of the first guide surfaces 19a toward the light exit surface 18 is refracted on slopes 22a to advance in a direction that is greatly displaced from a direction perpendicular to the slopes 22a. As a result, the rays L exit the slopes 22a to advance in the front direction. However, light that exits the slopes 22a in the front direction is light that reaches the slopes 22a at a specific angle. Light that reaches the slopes 22a at angles other than the specific angle does not exit the slopes 22a in the front direction.

As shown in FIG. 5(a), light generated by each point light source 15 enters the optical waveguide 14 in a spread range of an angle α. Thus, as shown in FIG. 5(b), the direction in which light generated by each point light source 15 advances when it is reflected on one of the first guide surfaces 19a varies depending on the position of the point light source 15 relative to a portion of each first guide surface 19a that admits the light from the light source 15. Therefore, only light that reaches each first guide surface 19a at a specific angle is emitted in the front direction of the optical waveguide 14 by the flat surface prisms 22. For example, in a case where the apex angle of the flat surface prisms 22 is 90°, and the angle θl defined by each first guide surface 19a and a plane parallel to the hypothetical plane P1 (see FIG. 3) is 45°, defective emission lines 23 (see FIG. 5(a)) appear in sections of the optical waveguide 14 where the angle α is 34°, or in each range that is spread by approximately 17° from the front direction of each point light source 15. A section indicated by a circle A of a broken line in FIG. 5(b) corresponds to a section indicated by a circle A of a broken line in FIG. 5(a).

In contrast, in the optical waveguide 14 shown in FIG. 1(a), which has the curved surface prisms 20, a portion of the light exit surface 18 between the peak lines of each adjacent pair of the prisms 20 is the curved surface 20a projection toward the back surface of the optical waveguide 14. Also, the angle defined by the hypothetical plane P1 and the tangent plane of the bottom portion 21a at a point on the bottom portion 21a is decreased as the point approaches the back surface of the optical waveguide 14. Therefore, light that would not be refracted to advance in the front direction of the optical waveguide 14 having the flat surface prisms 22 is refracted on the curved surface prisms 20 to advance in the front direction of the optical waveguide 14 as shown in FIG. 6(a).

As shown in FIG. 6(b), since a portion of the light exit surface 18 between the peak lines of each adjacent pair of the prisms 20 is the curved surface 20 a projecting toward the back surface of the optical waveguide 14, light from each of the point light sources 15 that is not reflected on any of the first guide surfaces 19a and advances through the optical waveguide 14 at a small angle relative to the hypothetical plane P1 only reaches a portion of one of the curved surfaces 20a that has a tangent plane inclined relative to the hypothetical plane P1 by a small angle, and does not reach a portion of the curved surface 20a having a tangent plane inclined relative to the hypothetical plane P1 by a large angle. Therefore, light that advances through the optical waveguide 14 at a small angle relative to the hypothetical plane P1 does not pass through any of the curved surfaces 20a, but is totally reflected on one of the curved surfaces 20a toward the back surface of the optical waveguide 14. The light reflected toward the back surface is reflected on one of the second guide surfaces 19b so that the incident angle to the curved surface 20a is no less than the critical angle, which causes the light to pass through the curved surface 20a and advance in the front direction of the optical waveguide 14. Therefore, the optical waveguide 14 shown in FIG. 1(a) reduces the amount of light that advances in directions other than the front direction of the optical waveguide 14 and increases the amount of light that exits the optical waveguide 14 and advances in the front direction of the optical waveguide 14.

Optical ray tracking simulations by Monte Carlo method were performed to confirm the superiority of the curved surface prisms 20 of FIG. 1(b) to the flat surface prisms 22 of FIG. 4(b), the details of which are shown below. The dimensions of the optical waveguide 14 used in the simulation analysis are shown in the table 1 below.

TABLE 1

| Parameter | Example | Comparison Example |
|---|---|---|
| Prism | Curved surface | Flat surface prism |
| | prism having cross- | having apex angle |
| | sectional profile | of 90° |
| | represented by | |
| | polynomial 1 | |
| Pitch of Prism | 0.25 mm | 0.25 mm |
| Angle defined by | 45° | 45° |
| First Guide Surface | | |
| 19a and Hypothetical | | |
| Plane P1 | | |
| Angle defined by | 1° | 1° |
| Second Guide Surface | | |
| 19b and Hypothetical | | |
| Plane P1 | | |

In Polynomial 1, Z represents a coordinate in a direction perpendicular to the hypothetical plane P1, X represents a coordinate in a direction parallel to the incident surface 14a and perpendicular to the Z axis, coefficient C is 50, coefficient K is −2, and coefficient C4 is 23.

The maximum value of the angle defined by the hypothetical plane P1 and the tangent plane of a curved surface 20a of each curved surface prism 20 is approximately 49°, and the minimum value of the angle is 0°. FIG. 8(a) shows a cross-sectional curve of the curved surface prism 20 shown in FIG. 1(b), and FIG. 8(b) shows a cross-sectional curve of the flat surface prism 22 shown in FIG. 4(b).

The influence of the directivity of the point light sources 15 is particularly noticeable in a section of the optical waveguide 14 that corresponds to a section of an display area 24 that is away by 10 mm from an edge at the side corresponding to the point light sources 15. The brightness ratio was measured in several spots in this section of the optical waveguide 14. The brightness ratio is the ratio of the brightness of a bright portion to the brightness of an adjacent dark portion. The average value of the measured brightness ratios was relativized by the example and the comparison example. The results of relativization are shown in table 2.

TABLE 2

| | | Comparison |
|---|---|---|
| | Example | Example |
| Relativized Average Value | 0.64 | 1.00 |
| of Brightness Ratio | | |

The simulation results shown in table 2 shows that if the optical waveguide 14 having the curved surface prisms 20 on the light exit surface 18 is used, the incidence of defective emission lines 23 is suppressed compared to the optical waveguide 14 having the flat surface prisms 22 on the light exit surface 18 (see FIG. 5(a)).

This embodiment provides the following advantages.

(1) In the optical waveguide 14 shown in FIG. 1(a), the saw-tooth shaped grooves 19 extending parallel to the incident surface 14a are provided on the back surface of the optical waveguide 14. Each saw-tooth shaped grooves 19 is defined by the first guide surface 19a and the second guide surface 19b. The curved surface prisms 20 extending perpendicular to the extending direction of the saw-tooth shaped grooves 19 are provided on the light exit surface 18 of the optical waveguide 14. A section of the light exit surface 18 between the peak lines of each adjacent pair of the prisms 20 is a curved surface 20a projecting toward the back surface of the optical waveguide 14. An angle defined by the hypothetical plane P1 and a tangent plane of each curved surface 20a at a point on the curved surface 20a decreases as the point approaches the back surface of the optical waveguide 14. The optical waveguide 14 thus configured effectively emit light in the front direction of the optical waveguide 14. Therefore, the area light source apparatus 13 incorporating the optical waveguide 14 does not require a prism sheet for collecting light to obtain a necessary brightness. Also, even if the point light sources 15 as shown in FIG. 1(a) are used, defective emission lines are hardly created in the optical waveguide 14. That is, the optical waveguide of FIG. 1(a) has a better quality than the conventional optical waveguide 14 since emission lines are not noticeable. The optical waveguide 14 of-FIG. 1(a) has a better efficiency than the conventional optical waveguide 14 since the brightness is improved.

(2) In the optical waveguide 14 shown in FIG. 1(a), a section of the light exit surface 18 between the peak lines of each adjacent pair of the prisms 20 is a curved surface 20a projecting toward the back surface of the optical waveguide 14. Compared to a case where a portion of the light exit surface 18 between the peak lines of each adjacent prisms 20 is formed of flat surfaces, the optical waveguide 14 in which a portion of the light exit surface 18 between the peak lines of each adjacent pair of the prisms 20 is the curved surface 20a projecting toward the back surface of the optical waveguide 14 emits in the front direction of the optical waveguide 14a great amount of light that has been reflected toward the light exit surface 18 by the first guide surfaces 19a.

(3) Since the area light source apparatus 13 incorporating the optical waveguide 14 shown in FIG. 1(a) does not need a prism sheet, the number of components is reduced. This reduces the number of assembling processes and the manufacture costs.

(4) The area light source apparatus 13 shown in FIG. 2 has the diffusion sheet 17. Therefore, even if the defective emission lines 23 are not completely eliminated in the optical waveguide 14, the diffusion sheet 17 suppresses the defective emission lines 23 to a level invisible to the naked eye.

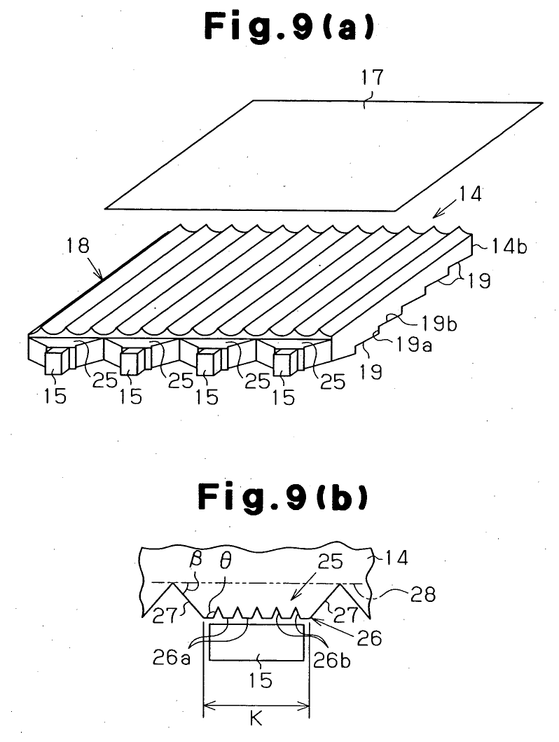

A second embodiment of the present invention will now be described with reference to FIGS. 9(a) and 9 (b). An optical waveguide 14 according to the second embodiment is different from the optical waveguide 14 according to the first embodiment 14 in that admitting portions 25 are formed on an edge (the incident surface 14a) of the optical waveguide 14. The number of the admitting portions 25 is the same as the number of the point light sources 15. The same reference numerals are given to those components that are same or similar as the corresponding components of the first embodiment, and detailed explanations are omitted.

As shown in FIG. 9(a), the admitting portions 25 are provided on an edge of the optical waveguide 14 that faces the point light sources 15 to guide light from the point light sources 15 into the optical waveguide 14. Each admitting portion 25 is formed continuous with the adjacent admitting portions 25. As shown in FIG. 9(b), the width of each admitting portion 25 is increased as the distance from the corresponding point light source 15 is increased. An incident portion 26 is an end face of each admitting portion 25 that faces the corresponding point light source 15. The width K of the incident portion 26 (lateral measurement as viewed in FIG. 9(b)) is greater than the width of the corresponding point light sources 15. Each incident portion 26 includes incident planes 26a and V-shaped grooves 26b. The incident planes 26a are spaced at an equal interval in a width direction of the admitting portion 25. The incident planes 26a are parallel to a hypothetical plane 28 that extends along the width direction of the admitting portion 25 at the interface between the admitting portions 25 and the optical waveguide 14. Each V-shaped groove 26b is located between an adjacent pair of the incident planes 26a. Surfaces defining each V-shaped groove 26b function as diffusing portions for diffusing light from the corresponding point light source 15. The angle θ defined by each of the surfaces defining the V-shaped groove 26b and the corresponding incident planes 26 a is preferably in a range no less than 120° and no more than 155°. The side surfaces of each admitting portion 25 are reflection planes. That is, the side surfaces reflect light that has been diffused by surfaces defining the V-shaped grooves 26b toward the optical waveguide 14. The angle β defined by each reflection plane 27 and the hypothetical plane 28 (see FIG. 9(b)) is preferably in a range no less than 35° and no more than 65°.

In the optical waveguide 14 shown in FIGS. 9(a) and 9 (b), most of light emitted by the point light sources 15 reaches the incident portions 26. Some of light that has reached the incident portion 26 enters the admitting portions 25 through the corresponding incident planes 26a. Most of light that enters the admitting portions 25 through the incident planes 26a at an angle perpendicular to the incident planes 26a. Therefore, the light advances in the admitting portions 25 and the optical waveguide 14 in a direction substantially perpendicular to the incident planes 26a, that is, in a direction substantially perpendicular to the hypothetical plane 28. On the other hand, the remainder of the light that has reached the incident portion 26 enters the admitting portions 25 through the corresponding surfaces the V-shaped grooves 26b. When entering the admitting portions 25 through the surfaces defining the V-shaped grooves 26b, the light is refracted on the surfaces defining the V-shaped grooves 26b. Most of the light that has been refracted on the surfaces defining the V-shaped grooves 26b is reflected on the reflection planes 27. This causes the light to advance in a direction substantially perpendicular to the hypothetical plane 28 in a portion of the optical waveguide 14 that corresponds to an area between each adjacent pair of the point light sources 15.

Optical ray tracking simulations by Monte Carlo method were performed to confirm the effectiveness of the admitting portions 25, the details of which are shown below. The dimensions of the optical waveguide 14 used in the simulation analysis are shown in table 3 below. The dimensions of the admitting portions 25 are shown in table 4 below.

TABLE 3

| | |
|---|---|
| Polynomial representing | Z = 100X²/(1 + (1 + 1700X²)^{0.5}) + 23X⁴ |
| cross-sectional profile of | |
| Prism 20 | |
| Pitch of Prism 20 | 0.25 mm |
| Angle defined by First Guide | 43 |
| Surface 19a and | |
| Hypothetical Plane P1 | |
| Angle defined by Second | 0.7 |
| Guide Surface 19b and | |
| Hypothetical Plane P1 | |

TABLE 4

| Parameter | Value |
|---|---|
| Angle β defined by Reflection Plane 27 and | 55° |
| Hypothetical Plane 28 | |
| Angle θ defined by Surfaces defining V-shaped | 132.5° |
| Groove 26b and Incident Plane 26a | |
| Pitch P of V-shaped Grooves 26b | 0.2 mm |
| Maximum Width W of Admitting Portion 25 | 14.25 mm |
| Width K of Incident Portion 26 | 6.4 mm |
| Distance h between Incident Plane 26a and | 5.6 mm |
| Hypothetical Plane 28 | |
| Ratio of Incident Plane 26a in Incident Portion 26 | 70% |

The brightness ratios were measured both in the optical waveguide 14 having the admitting portions 25 on the incident surface 14a and the optical waveguide having no admitting portions 25. Specifically, in both optical waveguides 14, the brightness ratios were measured at a plurality spots that were away from the incident surface 14a (the hypothetical plane 28) by 6.2 mm. The average value of the measured brightness ratios was relativized in the optical waveguides 14. The results of relativization are shown in table 5.

TABLE 5

| | With Admitting | Without Admitting |
|---|---|---|
| | Portions | Portions |
| Relativized Average Value | 0.79 | 1.00 |
| of Brightness Ratio | | |

The results shown in table 5 suggest that if the optical waveguide 14 with the admitting portions 25 on the incident surface 14a is used, the brightness is more uniform compared to the optical waveguide 14 without the admitting portions 25.

In addition to the advantages (1) to (4) of the first embodiment, the second embodiment has the following advantage.

(5) In the optical waveguide 14 shown in FIG. 9(a), light from the point light sources 15 is diffused by the admitting portions 25. This spreads the light to the entire optical waveguide 14. Therefore, dark portions of a significantly low brightness are not created in sections of the optical waveguide 14 that correspond to areas between adjacent point light sources 15. Also, bright portions of an excessively high brightness are not created in sections of the optical waveguide 14 that correspond to areas in front of the point light sources 15. Accordingly, brightness unevenness, which is likely to be present in section of the optical waveguide 14 in the vicinity of the point light sources 15, is reduced.

It should be apparent to those skilled in the art that the present invention may be embodied in many other specific forms without departing from the spirit or scope of the invention. Particularly, it should be understood that the invention may be embodied in the following forms.

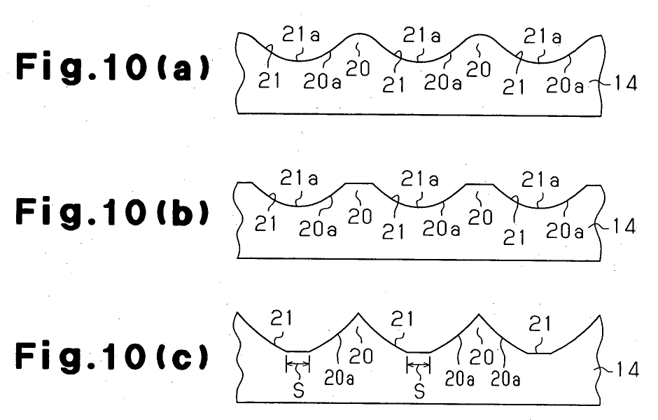

The prisms 20 may have shapes different from that shown in FIG. 1(b). However, even if the prisms 20 have a different shape from that shown in FIG. 1(b), the angle defined by the hypothetical plane P1 and a tangent plane of the bottom portion 21 a at a point on the bottom portion 21a must be reduced as the point approaches the back surface of the optical waveguide 14. Further, an angle defined by the hypothetical plane P1 and a tangent plane at a point on the curved surface 20a other than the bottom portion 21a does need to be reduced as the point approaches the back surface of the optical waveguide 14. For example, a part of each curved surface 20a that corresponds to the distal portion of the corresponding prism 20 does not need to project toward the back surface of the optical waveguide 14, but may project to a surface of the optical waveguide 14 facing away from the back surface as shown in FIG. 10(a). Alternatively, the portion may be flat as shown in FIG. 10(b). In a modification shown in FIG. 10(b), a part of each curved surface 20a that corresponds to the distal portion of the corresponding prism 20 is contained in the hypothetical plane P1. According to the modifications of FIGS. 10(a) and 10 (b), the amount of light that advances in the front direction of the optical waveguide 14 is less than that in the case of FIGS. 1(a) and 1(b), where the optical waveguide 14 has the curved surface prisms 20, but more than that in the case of FIG. 4(b), where the optical waveguide 14 has the flat surface prisms 22 instead of the curved surface prisms 20.

The prisms 20 may be arranged so that each adjacent pair of the prisms 20 are not continuous. For example, as shown in FIG. 10(c), each prism 20 may be spaced from the adjacent prisms 20 by a predetermined distance S. A mold for producing the optical waveguide 14 in which each prism 20 is spaced from the adjacent prisms 20 by the predetermined distance S is obtained by cutting a base with a blade the shape of which corresponds to that of the prism 20 at a predetermined interval. This mold is easier to obtain than the mold for producing the optical waveguide in which each prism 20 is continuous to the adjacent prisms 20.

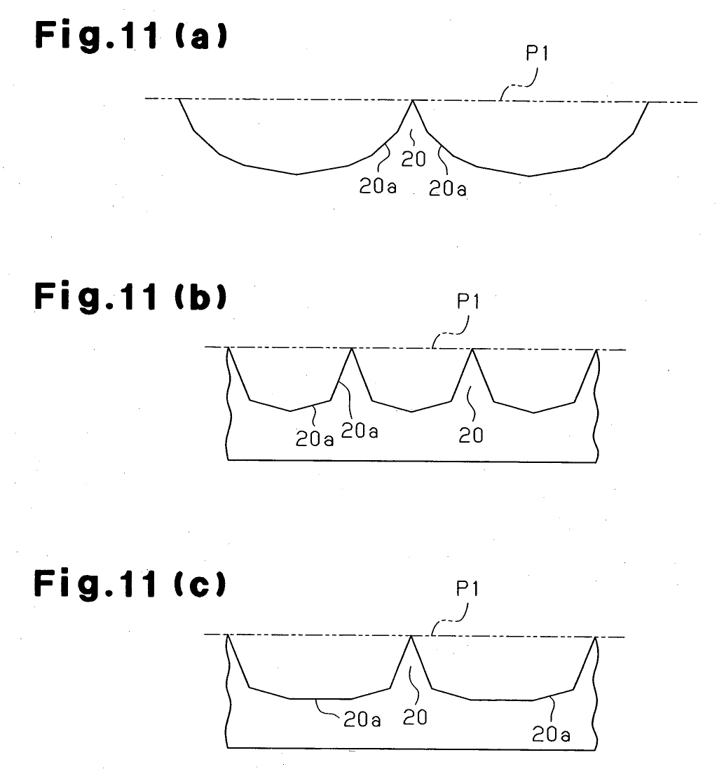

A section of the light exit surface 18 between the peak lines of each adjacent pair of the prisms 20 does not entirely curved to project toward the back surface of the optical waveguide 14, but may contain a flat portion. That is, the groove 21 formed between the peak lines of each adjacent pair of the prisms 20 does not be defined solely by a curved surface, but may be defined by a curved surface and a flat surface. For example, as shown in FIGS. 11(a) to 11(c), each groove 21 may be defined by planes 20 a each of which is inclined by a different angle with respect to the hypothetical plane P1. The optical waveguides 14 of these modifications have the same advantages as the optical waveguide 14 shown in FIG. 1(a).

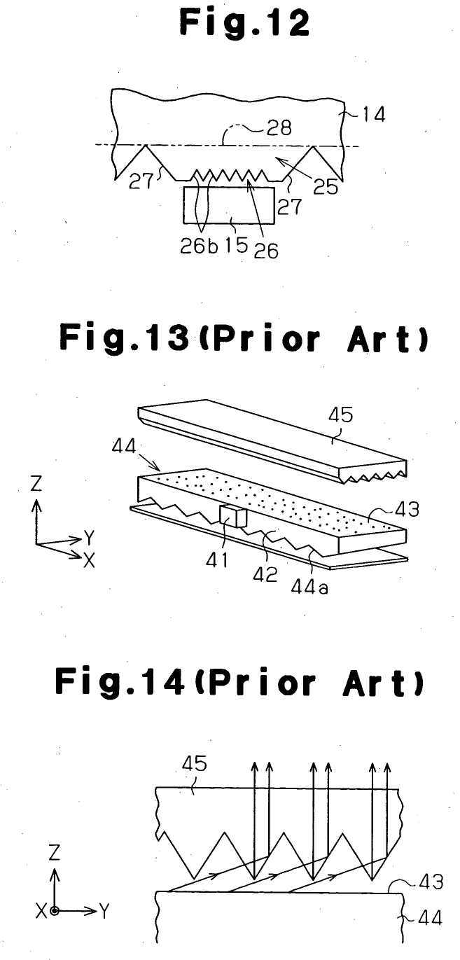

In FIG. 9(b), each admitting portions 25 includes the alternately arranged incident planes 26a and V-shaped grooves 26b. This configuration may be changed to the one shown in FIG. 12, where each V-shaped groove 26b is continuously formed with the adjacent V-shaped grooves 26b.

The admitting portions 25 may be omitted and the incident portions 26 may be directly formed on the incident surface 14a. In this case, light from the point light sources 15 is greatly diffused in a plane perpendicular to the thickness direction of the optical waveguide 14 compared to the case of the optical waveguide 14 shown in FIG. 1(a), which has the flat incident surface 14a.

The macroscopic thicknesses of the optical waveguides 14 shown in FIGS. 1(a) and 9(a) do not need to be uniform. For example, the optical-waveguide 14 may be shaped as a wedge so that the thickness is gradually reduced from the incident surface 14a toward the opposite surface 14b. Alternatively, the thickness of the optical waveguide 14 at a middle portion may be greater than the thickness in other portions of the optical waveguide 14.

In the area light source apparatus 13 shown in FIG. 2, the diffusion sheet 17 may be omitted. The diffusion sheet 17 reduces brightness unevenness in the entire light exit surface of the area light source apparatus 13. However, depending on the required definition of the liquid crystal display 11 using the area light source apparatus 13, brightness unevenness does not cause any problems in some cases if there is no diffusion sheet 17.

Therefore, the present examples and embodiments are to be considered as illustrative and not restrictive and the invention is not to be limited to the details given herein, but may be modified within the scope and equivalence of the appended claims.

1. An optical waveguide, comprising:
a first surface and a second surface, wherein the first and second surfaces are located at opposite sides of the optical waveguide, and
a third surface connecting the first and second surfaces with each other,
wherein the optical waveguide receives light through the third surface and emits the light to the outside through an area on the second surface,
wherein a plurality of first grooves are formed on the first surface, each first groove being defined by a section of the first surface, wherein each of the sections of the first surface defining the first grooves includes a reflection surface, each reflection surface reflects light that enters the optical waveguide through the third surface so that the light advances toward the second surface, wherein the extending direction of the reflection surfaces is parallel to the third surface, and
wherein a plurality of projections are formed on the second surface, the projections extending perpendicular to the extending direction of the reflection surfaces, each projection having a peak line, wherein a second groove is provided between the peak lines of each adjacent pair of the projections, each second groove being defined by a section of the second surface between the peak lines of the corresponding projections, wherein each of the sections of the second surface defining the second grooves includes a bottom portion, the bottom portion being located closer to the first surface than a midpoint of the second groove in the depth direction, and wherein an angle defined by a tangent plane of each bottom portion at a point on the bottom portion and a hypothetical plane that contains the peak lines of all the projections decreases as the point approaches the first surface.

2. The optical waveguide according to claim 1, wherein each projection is continuously formed with the adjacent projections.

3. The optical waveguide according to claim 1, wherein each section of the second surface between the peak lines of an adjacent pair of the projections is a curved surface projecting toward the first surface.

4. The optical waveguide according to claim 1, wherein each section of the second surface between the peak lines of an adjacent pair of the projections includes a flat surface.

5. The optical waveguide according to claim 1, wherein each section of the second surface between the peak lines of an adjacent pair of the projections consists of a plurality of flat surfaces.

6. The optical waveguide according to claim 1, wherein the minimum value of the angle defined by a tangent plane of each bottom portion at a point on the bottom portion and the hypothetical plane is no more than 100.

7. The optical waveguide according to claim 6, wherein the minimum value of the angle defined by a tangent plane of each bottom portion at a point on the bottom portion and the hypothetical plane is 0°.

8. The optical waveguide according to claim 1, further comprising an admitting portion for guiding light from a light source to the optical waveguide while diffusing the light.

9. The optical waveguide according to claim 8, wherein the admitting portion extends from the third surface toward the light source and includes an incident portion for receiving light from the light source, wherein the admitting portion has a width that is widened from the incident portion toward the third surface, wherein the incident portion includes a plurality of incident planes and a plurality of diffusing portions, the incident planes being arranged along the width direction of the admitting portion and parallel to the third surface, each diffusing portion being located between an adjacent pair of the incident planes to diffuse light from the light source, wherein the admitting portion further includes a reflection portion that reflects light diffused by the diffusing portions so that the light advances toward the third surface.

10. An area light source apparatus, comprising:
a point light source; and
an optical waveguide that receives light generated by the point light source,
wherein the optical waveguide includes:
a first surface and a second surface, wherein the first and second surfaces are located at opposite sides of the optical waveguide, and
a third surface connecting the first and second surfaces with each other,
wherein the optical waveguide receives light through the third surface and emits the light to the outside through an area on the second surface,
wherein a plurality of first grooves are formed on the first surface, each first groove being defined by a section of the first surface, wherein each of the sections of the first surface defining the first grooves include a reflection surface, each reflection surface reflects light that enters the optical waveguide through the third surface so that the light advances toward the second surface, wherein the extending direction of the reflection surfaces is parallel to the third surface, and
wherein a plurality of projections are formed on the second surface, the projections extending perpendicular to the extending direction of the reflection surfaces, each projection having a peak line, wherein a second groove is provided between the peak lines of each adjacent pair of the projections, each second groove being defined by a section of the second surface between the peak lines of the corresponding projections, wherein each of the sections of the second surface defining the second grooves includes a bottom portion, the bottom portion being located closer to the first surface than a midpoint of the second groove in the depth direction, and wherein an angle defined by a tangent plane of each bottom portion at a point on the bottom portion and a hypothetical plane that contains the peak lines of all the projections decreases as the point approaches the first surface.

11. The area light source apparatus according to claim 10, further comprising a diffusion sheet provided on the second surface of the optical waveguide.

12. A liquid crystal display, comprising:
a liquid crystal panel having a display surface;
an area light source apparatus provided on a surface of the liquid crystal panel that faces away from the display surface,
wherein the area light source apparatus includes:
a point light source; and
an optical waveguide that receives light generated by the point light source,
wherein the optical waveguide includes:
a first surface and a second surface, wherein the first and second surfaces are located at opposite sides of the optical waveguide, and
a third surface connecting the first and second surfaces with each other,
wherein the optical waveguide receives light through the third surface and emits the light to the outside through an area on the second surface,
wherein a plurality of first grooves are formed on the first surface, each first groove being defined by a section of the first surface, wherein each of the sections of the first surface defining the first grooves include a reflection surface, each reflection surface reflects light that enters the optical waveguide through the third surface so that the light advances toward the second surface, wherein the extending direction of the reflection surfaces is parallel to the third surface, and
wherein a plurality of projections are formed on the second surface, the projections extending perpendicular to the extending direction of the reflection surfaces, each projection having a peak line, wherein a second groove is provided between the peak lines of each adjacent pair of the projections, each second groove being defined by a section of the second surface between the peak lines of the corresponding projections, wherein each of the sections of the second surface defining the second grooves includes a bottom portion, the bottom portion being located closer to the first surface than a midpoint of the second groove in the depth direction, and wherein an angle defined by a tangent plane of each bottom portion at a point on the bottom portion and a hypothetical plane that contains the peak lines of all the projections decreases as the point approaches the first surface.

13. The liquid crystal display according to claim 12, wherein the area light source apparatus further comprises a diffusion sheet provided on the second surface of the optical waveguide.
